(19) United States
(12) Patent Application Publication
(10) Pub. No.: US 2009/0153424 A1
(43) Pub. Date: Jun. 18, 2009

(54) DUAL-BAND ANTENNA FOR RECEIVING VHF AND UHF SIGNAL AND COMMUNICATION DEVICE INCLUDING THE SAME

(75) Inventors: Byung Hoon Ryou, Seoul (KR); Won Mo Sung, Gyeonggi-do (KR); Jae Hoon Choi, Seoul (KR); Seung Gu Jeon, Seoul (KR); Woo Young Choi, Seoul (KR); Won Seob Kim, Chungcheongbuk-do (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: E.M.W. ANTENNA CO. LTD, Seoul (KR)

(21) Appl. No.: 12/281,620

(22) PCT Filed: Mar. 16, 2007
(86) PCT No.: PCT/KR2007/001298

§ 371 Date: Dec. 2, 2008

(30) Foreign Application Priority Data
Mar. 20, 2006 (KR) 10-2006-0025223

(51) Int. Cl. H01Q 13/10; H01Q 1/38

(52) U.S. Cl. 343/767; 343/700 MS

(57) ABSTRACT

Disclosed herein is a dual-band antenna for a terminal for receiving VHF and UHF signals. A radiator of the dual-band antenna for a terminal for receiving VHF and UHF signals according to the present invention comprises a first patch bent at a part of a distal end thereof, and a second patch electrically connected to the first patch and formed in a spiral shape. A longitudinal portion of the second patch is constructed superposedly in a multi-structure in parallel with that of the first patch, so that the broadband of the VHF and UHF can be covered through an inverted L-shaped folded antenna structure.

### TECHNICAL FIELD

The present invention relates to an antenna for a portable communication terminal, and more particularly, to a dual-band antenna for receiving VHF and UHF signals.

### BACKGROUND ART

Digital Multimedia Broadcasting (DMB) refers to a digital radio transmission system for sending services of multimedia such as video, audio and data to mobile devices such as mobile phones during the movement of a user, which are impossible through a conventional analog television broadcasting (NTSC) or a digital television broadcasting (ATSC). A terrestrial DMB is directed toward a universal free service and is scheduled to be broadcasted through a very high frequency (VHF) channel.

The terrestrial DMB employs a type which receives an electromagnetic wave irradiated from a broadcasting station as in common broadcasting. Thus, such a terrestrial DMB enables broadcasting at different frequencies depending on regions similarly to current television broadcasting unlike a satellite DMB which enables concurrent broadcasting at the same frequency nationwide. In Korea, the terrestrial DMB permits transmission broadcasting services through channels 8 to 12 of a sky-wave VHF frequency band which is vacant currently. For this reason, it is impossible to provide broadcasting services by the same frequency network nationwide, and thus it is a high possibility that the terrestrial DMB will be developed toward a multi frequency network (MFN) in consideration of properties by regions.

In addition, the terrestrial DMB has originally started from the concept of a vehicle terminal, but is scheduled to be operated centering on a portable terminal similarly to the satellite DMB as domestic terminal manufacturers succeeds in development of commercial chips which can be implemented in the form of the portable cell phones.

Initially, the terrestrial DMB designed to complement an American-type digital TV broadcasting system which makes mobile reception impossible is a type which is developed by application of a video technology to the digital audio broadcasting (DAB) as an European standard. Such a new type attracts the international interest as the terrestrial DMB is highly likely to be adopted as a technology standard in Europe as the central region of DAM. However, problems associated with an antenna are caused in watching such a terrestrial DMB. Since the terrestrial DMB employs a VHF frequency of 200M□, the length of an antenna of the terrestrial DMB adopting an existing technology reaches 30□. The antenna of the terrestrial DMB may employ a chip antenna, but has a critical demerit in that it is deteriorated in performance as compared to an external antenna.

Digital Television (DTV, 470 MHz˜810 MHz) being serviced through a ultra high frequency (UHF) band is proposed as a technology which has been presently spotlighted along with the VHF band of the terrestrial DMB. This DTV provides broadcasting services through channels 14 to 69 of a UHF band, and is being spotlighted as a technology which is expected to be developed in future in Europe, Japan, China and the U.S. along with the terrestrial DMB.

Conventionally, a helical antenna or dipole-type antenna has been used in order to receive a broadcasting signal according to such a terrestrial DMB of a VHF band or DTV of a UHF band. But, at present, there is a need for a new-type antenna due to the restriction of size according to miniaturization of a receiver terminal. Also, there is a need for a dual-band antenna for receiving VHF and UHF signals according to the domestic and foreign technological trends.

Further, since an available frequency band for the terrestrial DMB and the DTV ranges from 15% to 50% in bandwidth, it is indispensable to develop an antenna capable of covering this broad band while having a dual-band property.

### DISCLOSURE OF INVENTION

### Technical Problem

Accordingly, the present invention has been made in an effort to solve the above-mentioned problems occurring in the prior art, and it is an object of the present invention to provide a miniaturized dual-band and broad-band antenna which provides an efficient signal sensitivity in both VHF band and UHF band, and a wireless communication terminal including the antenna.

### Technical Solution

To accomplish the above object, according to one aspect of the present invention, there is provided a dual-band antenna for a terminal for receiving VHF and UHF signals.

The dual-band antenna comprises: a radiator arranged in parallel with a ground plane; and a feed line connected to the radiator, wherein the radiator comprises a first patch connected to the feed line and bent at a certain portion thereof, and a second patch electrically connected to the first patch in such a fashion as to form a multi-layered structure, the second patch being formed in a spiral shape.

Preferably, the first patch may have an electric length for covering a UHF band, and the second patch may have an electric length for covering a VHF band through inter-connection with the first patch.

Also, preferably, an open stub may be provided at a portion ranging from a feed terminal of the certain portion of the first patch to a distal end of the first patch in one direction, so that the length of the open stub is adjusted to cover the UHF broad band.

Preferably, an open stub may be provided at a portion ranging from certain position of the second patch to a distal end of the second patch in one direction, so that the length of the open stub is adjusted to cover the UHF broad band.

In the meantime, the second patch is divided at a predetermined portion, and an LC resonance circuit is connected between the divided portions of the second patche so as to cover the VHF broad band.

Further, more preferably, a bent conductor may be formed at an inner side of the second patch so as to correct the frequency characteristic due to the LC resonance circuit.

Preferably, at least a part of the first patch may be superposed with at least a part of the second patch in such a fashion as to be electromagnetically coupled with at least the part of the second patch.

Preferably, the dual-band antenna may be internally mounted in the terminal for receiving VHF and UHF signals.

In addition, preferably, the VHF signal is an available frequency band signal for a terrestrial-digital multimedia broadcasting (T-DMB) service.

Moreover, according to another embodiment of the present invention, there is also provided a wireless communication terminal including the dual-band antenna.

### ADVANTAGEOUS EFFECTS

According to the present invention, it is possible to provide a miniaturized dual-band and broad-band antenna which provides an efficient signal sensitivity in both terrestrial DMB band and UHF band, and a wireless communication terminal including the antenna.

### BRIEF DESCRIPTION OF THE DRAWINGS

FIG. 1 is a diagrammatic view illustrating a dual-band antenna for a terminal for receiving VHF and UHF signals according to one embodiment of the present invention;

FIG. 2 is a graph illustrating a simulation result of a return loss according to a change of frequency in a dual-band antenna for a terminal for receiving VHF and UHF signals according to one embodiment of the present invention;

FIG. 3 is a graph illustrating a simulation result of a change of a resonance frequency according to a change of the length (L1) of an open stub of FIG. 1;

FIG. 4 is a graph illustrating a simulation result of a change of a resonance frequency according to a change of the length (L2) of an open stub of FIG. 1;

FIG. 5 is a photograph illustrating a dual-band antenna for a terminal for receiving VHF and UHF signals, which has been actually manufactured according to an embodiment of the present invention;

FIG. 6 is a graph illustrating a return loss measured for a dual-band antenna for a terminal for receiving VHF and UHF signals, which has been actually manufactured according to an embodiment of the present invention;

FIG. 7 is a graph illustrating a gain property of the VHF band signal measured for a dual-band antenna for a terminal for receiving VHF and UHF signals, which has been actually manufactured according to an embodiment of the present invention; and

FIG. 8 is a graph illustrating a gain property of the UHF band signal measured for a dual-band antenna for a terminal for receiving VHF and UHF signals, which has been actually manufactured according to an embodiment of the present invention.

### MODE FOR THE INVENTION

Reference will now be made in detail to a dual-band antenna for a terminal for receiving VHF and UHF signals according to a preferred embodiment of the present invention with reference to the attached drawings.

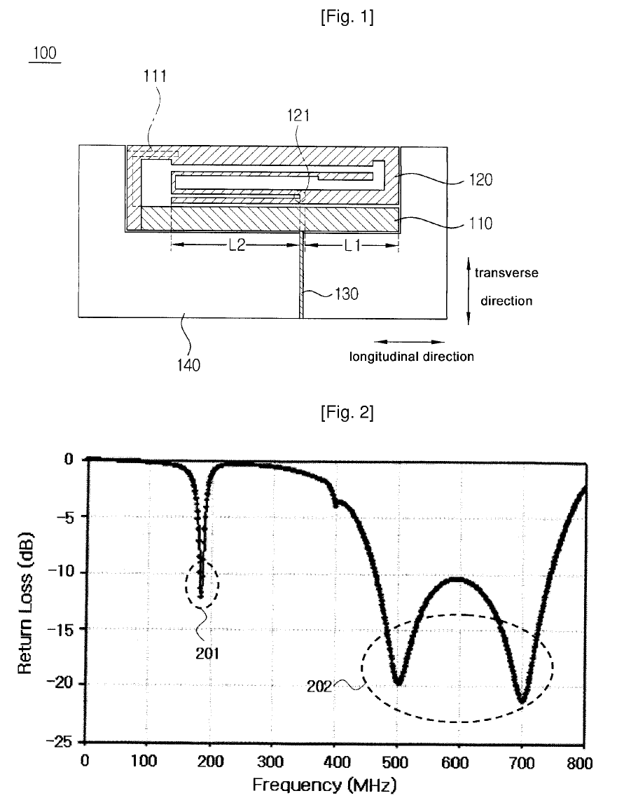

FIG. 1 is a diagrammatic view illustrating a dual-band antenna for a terminal for receiving VHF and UHF signals according to one embodiment of the present invention.

Referring to FIG. 1, the dual-band antenna 100 for a terminal for receiving VHF and UHF signals according to one embodiment of the present invention is provided with a multi-layered structure in which a first patch 110 is positioned at a lower side on the drawing and a second patch 120 is positioned at an upper side on the drawing. In this embodiment, the first patch 110 and the second patch 120 corresponding to a radiator provides an inverted L-shaped folded antenna, and can cover both the VHF band and the UHF band of a terrestrial DMB, etc. That is, it is possible to cover the UHF band along a conductor path which the first patch 110 folded at a part of a distal end thereof constitutes, and to cover the VHF band of the terrestrial DMB, etc., through a long path electrically connected to the second patch 120 via the first patch.

To this end, the second patch 120 is electrically connected to the first patch 110 at a certain position, for example, at a lower end in a portion indicated by a dotted line of the left side of the drawing, and is formed in a rectangular spiral shape. Also, a longitudinal portion of the second patch 120 is substantially arranged in parallel with that of the first patch 110.

Particularly, the dual-band antenna 100 for a terminal for receiving VHF and UHF signals according to this embodiment provides an inverted L-shaped folded antenna in its entirety. In this case, the first patch 110 is implemented by a length close to the length of ¼ wavelength with respect to the UHF band, and a long electrical path composed of the first patch 110 and the second patch 120 is implemented by a length close to the length of ¼ wavelength with respect to the VHF band.

As shown in FIG. 1, the dual-band antenna 100 for a terminal for receiving VHF and UHF signals comprises an electrical path according to the first patch 110 and the second patch 120 as well as a magnetic path implemented by a contiguous space between the two patches

For the purpose of the coupling between the both patches 110 and 120, the first patch 110 and the second patch 120 is at least partially superposed with each other. Also, in order to additionally provide a coupling effect between conductors by the first patch 110 and the second patch 120 and the magnetic path, the second patch 120 has a type in which a conductor is branched off at a certain position 121 of a longitudinal direction.

As a result, the dual-band antenna 100 for a terminal for receiving VHF and UHF signals according to this embodiment is implemented by the inverted L-shaped folded antenna structure, and may be implemented in a small size of an approximately 0.06 wavelength as compared to the terrestrial DMB frequency band. In addition, the first patch 110 and the second patch 120 have a multi-layered structure consisting of an upper layer and a layer so as to cover the dual-band through a small antenna structure.

Furthermore, the dual-band antenna 100 for a terminal for receiving VHF and UHF signals according to this embodiment can tune a broadband property of the UHF band by having open stubs formed at both distal ends of the first patch 110 and the second patch 120. That is, there exists a first open stub having the length L1 ranging from a micro-strip feed line 130 connected to a certain longitudinal portion of the first patch 110 to a right distal end of the first patch 110. Also, there exists a second open stub having the length L2 ranging from a certain longitudinal position 121 of the second patch 120 to a left distal end of the second patch 120.

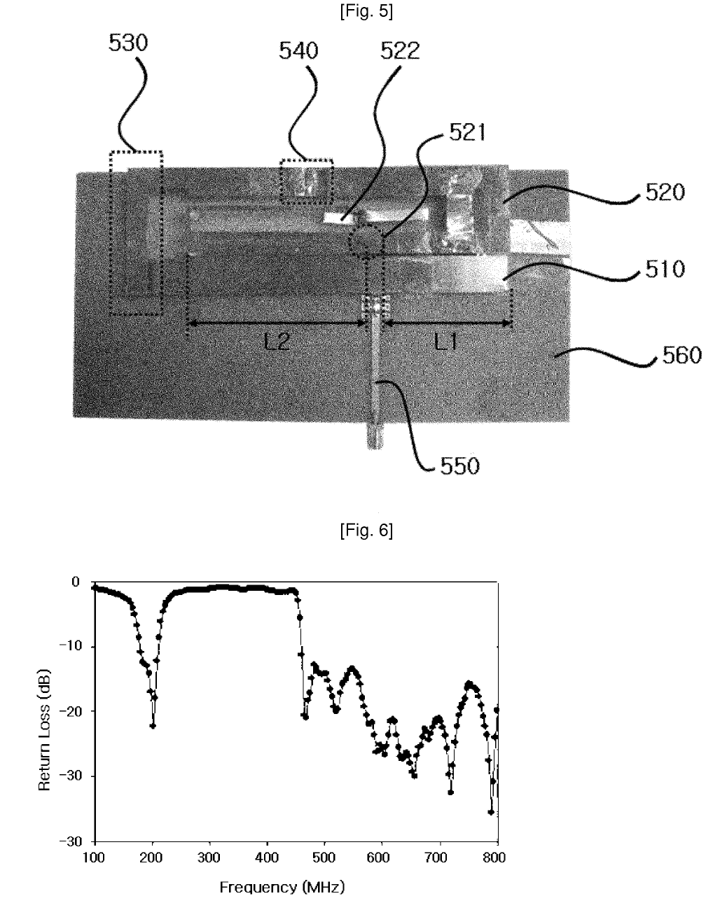

As described later, the dual-band antenna 100 for a terminal for receiving VHF and UHF signals according to this embodiment can cover the broadband of the UHF by adjusting the length L2 of the second stub. Moreover, the dual-band antenna 100 for a terminal for receiving VHF and UHF signals enables the tuning of the broadband property of the VHF band through an LC resonance circuit (not shown) connected to the certain position of the second patch 120. That is, the LC resonance circuit composed of an inductor and a capacitor can be additionally provided in order to improve a receiving performance of a VHF band signal. The LC resonance circuit will be described later in detail with reference to FIG. 5.

FIG. 2 is a graph illustrating a simulation result of a return loss according to a change of frequency in a dual-band antenna 100 for a terminal for receiving VHF and UHF signals according to one embodiment of the present invention.

Referring to FIG. 2, like reference numeral 201, a return loss of the VHF band of the terrestrial DMB, etc., is measured, and like reference numeral 202, a return loss of the UHF band ranging from 470 MHz to 740 MHz) is measured. That is, it can be seen from the graph that a return loss of less than −10 dB is observed in most regions of the UHF band in case of the reference numeral 202 whereas a return loss of less than −10 dB is observed in only a narrow-bandwidth of the terrestrial DMB band ranging from 180 MHz to 210 MHz in case of the reference numeral 201. This result may occur by a variable depending on the size of the dual-band antenna 100 and the size of a ground plate 140. Such a narrow bandwidth property in the VHF band of the terrestrial DMB can be solved by the LC resonance circuit for broadband, which will be described later.

The ground plate 140, as shown in FIG. 1, may be positioned in parallel with a plane where the first patch 110 and the second patch 120 are placed, but the size of the ground plane can vary depending on the directionality of an antenna, gain requirements and the like.

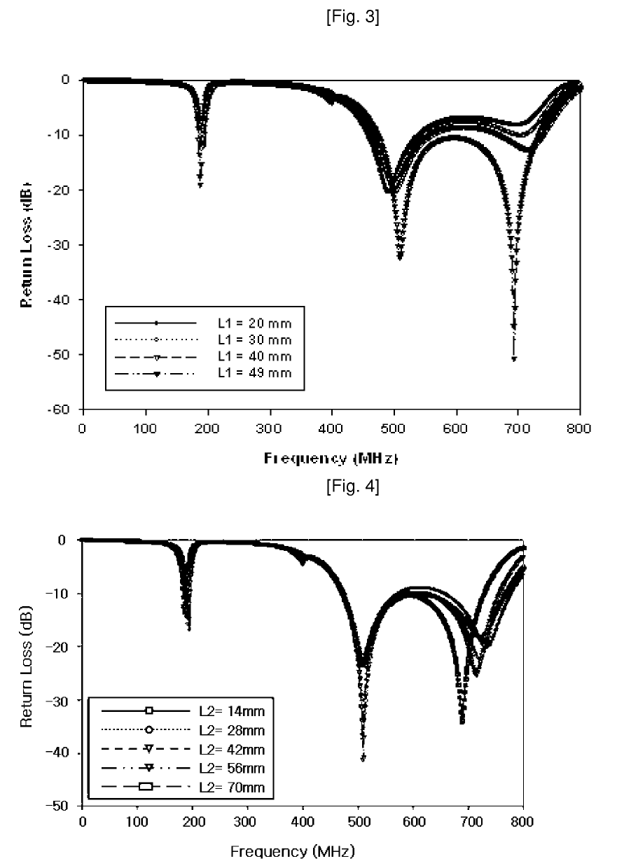

FIG. 3 is a graph illustrating a simulation result of a change of a resonance frequency according to a change of the length (L1) of an open stub of FIG. 1, and FIG. 4 is a graph illustrating a simulation result of a change of a resonance frequency according to a change of the length (L2) of an open stub of FIG. 1.

Each of the lengths L1 and L2 of the open stubs is an important variable which adjusts a frequency bandwidth, particularly the UHF bandwidth, which is proved through the graphs of FIGS. 3 and 4.

In FIG. 3, there is shown a change of a resonance frequency according to a change of the length (L1) of the open stub. That is, FIG. 3 shows that as the length (L1) of the open stub increases, a change of a resonance frequency of the terrestrial DMB band is weak but the resonance frequency of the UHF band is apparently transited to a high frequency domain and concurrently exhibits a broadband property. Furthermore, FIG. 4 also shows that as the length (L2) of the open stub increases, a change of a resonance frequency of the VHF band of the terrestrial DMB is weak whereas a change of a resonance frequency of the UHF band is remarkable and the bandwidth is extended.

Resultantly, it can be seen through the simulation results of FIGS. 3 and 4 that the lengths L1 and L2 of the two open stubs are important variables for satisfying the UHF bandwidth, and the bandwidth of the UHF band can be extended while not affecting the property of the VHF band by adjusting the lengths L1 and L2 of the two open stubs

FIG. 5 is a photograph illustrating a dual-band antenna for a terminal for receiving VHF and UHF signals, which has been actually manufactured according to an embodiment of the present invention.

An optimal variable conforming to the operating frequency can be determined with respect to the dual-band antenna for a terminal for receiving VHF and UHF signals according to the present invention using HFSS as software for analysis and design of a three-dimensional structure, and the length and size of the antenna can be determined accordingly.

As shown in FIG. 5, the dual-band antenna for a terminal for receiving VHF and UHF signals according to an embodiment of the present invention comprises an FR4 substrate 560 with a thickness of 1.6 mm used as a ground plate and a micro-strip feed line 550 with a width of 3 mm. In this case, the FR4 substrate 560 is arranged in parallel with the first and second patches 510 and 520 and has a dielectric constant of 4.4.

The dual-band antenna for a terminal for receiving VHF and UHF signals according to an embodiment of the present invention can cover a signal of the VHF band of the terrestrial DMB, etc., close to a center frequency of 200 MHz, and a signal of the UHF band close to a center frequency of 600 MHz. The antenna according to this embodiment can be implemented in a multi-layered structure including the first patch 510 and the second patch 520 in order to implement an antenna used in such a dual-band. The first patch 510 is formed in an L-shape which is bent at a distal end thereof, and the second patch 520 is formed in a rectangular spiral shape. The first patch 510 and the second 520 are interconnected at a certain portion, for example, at a lower end of a portion indicated by a dotted line of reference numeral 530.

In FIG. 5, the dimension of the substrate 560 actually manufactured has a longitudinal length of 200 mm and a transverse length of 100 mm. The first patch 510 and the second patch 520 was manufacture to have a longitudinal length of 150 mm and a transverse length of 50 mm, respectively, and a height of 10 mm. As shown in FIG. 1, the broadband property of the UHF band can tuned through the lengths L1 and L2 of the open stubs, and the LC resonance circuit 540 positioned at the upper central disconnected portion of the second patch 420 was used to tune the broadband property of the VHF band of the DMB, etc. The LC resonance circuit 540 is constructed such that the inductor and the capacitor are connected in parallel with each other at least one by one between two parts into which the second patch 520 is branched off at the disconnected portion. At this time, an inductance value and a capacitance value of the LC resonance circuit 540 can be designed to have an appropriate value so as to improve the receiving performance of the VHF band signal of the DMB, etc. The use of the LC resonance circuit 540 can improve the broadband property of the VHF band. In this case, a bent patch 522 is installed adjacent to a distal end of an inner side of the second patch 520 to correct the broadband property. That is, it is possible to compensate for a change of the broadband property according to the additional installation of the LC resonance circuit 540 through the bent patch 522

In addition, as described above, in order to additionally provide a coupling effect between conductors by the first patch 510 and the second patch 520 and a magnetic path, the second patch 520 has a type in which a conductor is branched off at a certain position 521 in the longitudinal direction.

Since the VHF signal of the terrestrial DMB has a relatively large wavelength, the simulation result exhibits a narrow-band property without any large change of the frequency in depending on the size of the antenna and the size of the ground plate. The antenna of this embodiment adopts a broadband technique using the LC resonance circuit to cover the bandwidth of the terrestrial DMB.

FIG. 6 is a graph illustrating a return loss measured for a dual-band antenna for a terminal for receiving VHF and UHF signals, which has been actually manufactured according to an embodiment of the present invention.

It can be found from the graph of FIG. 6 that the dual-band antenna for a terminal for receiving VHF and UHF signals, which has been actually manufactured cover a bandwidth of approximately 30 MHz for the VHF band of the terrestrial DMB, etc., and cover a wide bandwidth of more than approximately 300 MHz for the UHF band based on a voltage standing wave ratio (VSWR)<2 standard.

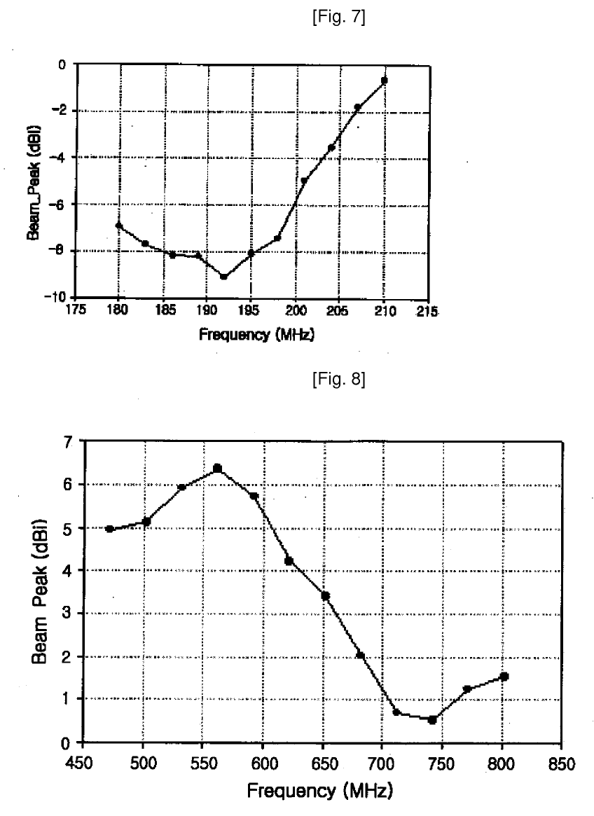

FIG. 7 is a graph illustrating a gain property of the VHF band signal measured for a dual-band antenna for a terminal for receiving VHF and UHF signals, which has been actually manufactured according to an embodiment of the present invention, and FIG. 8 is a graph illustrating a gain property of the UHF band signal measured for a dual-band antenna for a terminal for receiving VHF and UHF signals, which has been actually manufactured according to an embodiment of the present invention.

The VHF and UHF band signals have shown measured gain properties of more than −10 dBi for DMB bandwidth ranging from 180 MHz to 210 MHz and the UHF bandwidth ranging from 470 MHz to 740 MHz. Particularly, the maximum gain in the UHF band has shown a high gain property of more than 6 dBi.

The dual-band antenna for a terminal for receiving VHF and UHF signals according to one embodiment of the present invention is preferably implemented as a built-in antenna for the terminal for receiving VHF and UHF signals, but is not limited thereto. The dual-band antenna of the present invention may be implemented as an external antenna depending on the configuration of the system.

While the invention has been described in connection with what is presently considered to be practical exemplary embodiments, it is to be understood that the invention is merely exemplary and not limited to the disclosed embodiments. Therefore, a person skilled in the art can perform various changes and modifications based on a principle of the present invention, which falls in the scope of the present invention.

Therefore, the scope of the present invention should not be construed as being limited to the above described embodiment, but should be defined by the appended claims and the equivalents to the claims.

1. A dual-band antenna for a terminal for receiving VHF and UHF signals, comprising: a radiator arranged in parallel with a ground plane; and a feed line connected to the radiator, wherein the radiator comprises a first patch connected to the feed line and bent at a certain portion thereof, and a second patch electrically connected to the first patch in such a fashion as to form a multi-layered structure, the second patch being formed in a spiral shape.

2. The dual-band antenna according to claim 1, wherein the first patch has an electric length for covering a UHF band, and the second patch has an electric length for covering a VHF band through interconnection with the first patch.

3. The dual-band antenna according to claim 1, wherein an open stub is provided at a portion ranging from a feed terminal of the certain portion of the first patch to a distal end of the first patch in one direction, so that the length of the open stub is adjusted to cover the UHF broad band.

4. The dual-band antenna according to claim 1, wherein an open stub is provided at a portion ranging from a certain position of the second patch to a distal end of the second patch in one direction so that the length of the open stub is adjusted to cover the UHF broad band.

5. The dual-band antenna according to claim 1, wherein the second patch is divided at a predetermined portion, and an LC resonance circuit is connected between the divided portions of the second patche so as to cover the VHF broad band.

6. The dual-band antenna according to claim 5, wherein a bent conductor is formed at an inner side of the second patch so as to correct the frequency characteristic due to the LC resonance circuit.

7. The dual-band antenna according to claim 1, wherein at least a part of the first patch is superposed with at least a part of the second patch in such a fashion as to be electromagnetically coupled with at least the part of the second patch.

8. The dual-band antenna according to claim 1, wherein the dual-band antenna is internally mounted in the terminal for receiving VHF and UHF signals.

9. The dual-band antenna according to claim 1, wherein the VHF signal is an available frequency band signal for a terrestrial-digital multimedia broadcasting (T-DMB) service.

10. A wireless communication terminal including the dual-band antenna according to claim 1.
